(19) United States
(12) Patent Application Publication
(10) Pub. No.: US 2015/0210415 A1
(43) Pub. Date: Jul. 30, 2015

(54) Procedure and System for the Alignment of a Packaging Container

(71) Applicant: B&B - MAF GmbH & Co. KG, Hopsten (DE)

(72) Inventor: Thomas Bruns, Ibbenbuhren (DE)

(21) Appl. No.: 14/302,959

(22) Filed: Jun. 12, 2014

(30) Foreign Application Priority Data
Jan. 25, 2014 (DE) 12 2014 001 013.9

(51) Int. Cl. B65B 35/58; B65G 43/00; B65G 47/24

(52) U.S. Cl. CPC B65B 35/58; B65G 47/24; B65G 43/00

(57) ABSTRACT

The invention relates to a process for the alignment of a minimum of one packaging container, specifically a bag, during which the filled packaging container is moved in a horizontal direction in such a way that the packaging container has an infeed side at the front in the direction of movement and a rear side, whereby the filled packaging containers being fed to an aligning unit. A minimum of one gripper is approaching an upper edge of the packaging container and the position of the upper edge of the packaging container is being detected by sensors. The gripper is aligned to the upper edge of the packaging container and the packaging container is grasped by the aligned gripper.

The invention relates to a process for the alignment of a minimum of one packaging container during which the filled container is fed horizontally into the aligning unit so that the packaging container has an infeed side at the front in the direction of movement and a rear side. In addition, the invention relates to a process for the alignment and sealing of a packaging container and a device for the alignment and sealing of a packing container.

A system for the filling and sealing of bags, specifically of woven bags, is known from US 2012/0227363 A1. The system includes a plastic welding unit, a folding device and nip rollers. To seal, a section of the bag is folded over, welded via the welding unit and pressed together using the nip rollers. The seam is then sealed without the use of hot melt adhesives.

A problem in the sealing of plastic packaging containers, such as plastic woven bags, is the lack of stiffness of the material. Usually the filled packaging containers are fed by a conveyor belt or similar equipment to the sealing unit. As a result of the lack of stiffness of the plastic material, the position of the upper edge of the packaging container to be sealed changes between the filling stage and the sealing unit. In order to ensure that each packaging container is correctly sealed the upper edge of each packaging container must be exactly aligned. One possibility for tackling the problem of the varying position of the upper edge of the packaging containers is to select excess material above the desired weld position which is then cut to a differing extent, depending on the position of the upper edge, in order to maintain the exact position of the upper edge. If the amount of excess material were too low, this would lead to the packaging container not being sealed tightly. The excess packaging material selected to compensate the varying positions of the upper edges of the packaging containers is a significant cost factor, as it increases the overall cost of materials. Additionally, such a cutting process is not possible, for example, for packaging containers with a stepped-end cut.

The primary object of the present invention is to propose a process and equipment with which the unused excess packaging material can be minimized when sealing packaging containers, specifically woven bags, and with which the use of the described sealing equipment for the sealing of packaging containers with a stepped-end cut is made possible.

The solution to this task is provided through a process which is in accordance with the features of the patent claim 1, through a process which is in accordance with the features of the patent claim 9, with equipment which is in accordance with the features of the patent claim 10 and equipment which is in accordance with the features of the patent claim 14. Further developments and beneficial features are included in the appropriate sub-claims.

In a process for the alignment of a minimum of one packaging container, specifically a bag, during which the filled packaging container is moved in a horizontal direction in such a way that the packaging container has an infeed side at the front in the direction of movement and a rear side, it is proposed in the invention that the filled packaging containers are fed into a aligning unit, a minimum of one gripper approaches an upper edge of the packaging container, the position of the upper edge is detected by sensors, the gripper is aligned towards the upper edge of the packing container, the packaging container is grasped by the aligned gripper and the packaging container grasped by the gripper is aligned by a movement of the gripper. The packaging containers may include, for example, plastic bags, in particular plastic woven bags with a stepped-end cut, pinch bottom bags or plastic woven bags with a roll bottom. The packaging containers are filled and, after this is completed, they are fed onwards, for example, via a conveyor belt in order to be sealed. During this process, the packaging containers may be filled either from the side which later form the bottom of the packaging, i.e. from below, or from what will later be the upper side. The upper edge of the packaging container is designated as being the remaining open side of the packaging container which faces away from the conveyor belt. To correctly align the packaging containers for sealing, a gripper approaches the upper edge of the relevant packaging container. To that end, the position of the upper edge of the packaging container is detected by sensors and the gripper is aligned parallel to the upper edge of the packaging container. The gripper which is aligned along the upper edge of the packaging container records this upper edge and thus fixes it into place. The upper edge of the packaging container may, for instance, be in a slanting position which makes correct sealing with a sealing unit more difficult. Through the movement of the gripper, and thus of the detected upper edge of the packaging container, into a fixed position the upper edge of the packaging container can be precisely aligned. The packaging container may then, for example, be transferred in an accurate position to onward transporting equipment, e.g. a processing device, in particular a sealing unit, or directly fed to the sealing section.

In a further development of the process the gripper is moved vertically above the upper edge of the packaging container and the gripper is moved horizontally during which the movement speed of the gripper is adjusted to the speed of the transport device which conveys the packaging container. A packaging container may, for example, be fed via a transport device, in particular a conveyor belt, to the equipment or to the sealing section. Along the transport route the gripper can be moved at the same speed as the conveyed packaging container. Thus the gripper can be moved vertically over the upper edge of the packaging container during the horizontal movement of the packaging container and grasp it.

In a further development of the process a minimum of one position of the packaging container which is being moved by the transport device is detected by sensors and the gripper is moved based on the data from these sensors. The sensor for detecting the position of the packaging container which is being transported via a transport device, e.g. on a conveyor belt can, for example, take the form of an optical sensor, specifically a light barrier. This sensor may be located on the transport device. An item such as a light barrier may be arranged on a conveyor belt vertically to the conveying direction in such a way that packaging containers which pass the light barrier are detected by the sensor. Through the detection of a packaging container on the conveyor belt a control signal may be sent to the gripper so that it is moved from its stand-by position to the position of the packaging container on the conveyor belt. The speed of the conveyor belt and the horizontal movement speed of the gripper should preferably be synchronized so that the gripper can grasp the packaging container during its movement.

In a preferred form of the process the gripper has a minimum of two sensors for the sensor-based determination of the upper edge of the packaging container and the gripper is aligned in accordance with the upper edge of the packaging container determined by the sensors. The gripper has a minimum of two sensors with which the upper edge of the packaging container can be detected. These sensors may take the form of optical sensors, specifically light barriers. The sensors are arranged in such a way in relation to the gripper that they detect the position of this upper edge during the vertical movement of the gripper above the upper edge of the packaging container. When the upper edge is detected the gripper should preferably be aligned parallel to the upper edge and closed in such a way that the upper edge of the packaging container is fixed into place.

In a particularly preferred version of the process the minimum of two sensors are spaced apart from one another on the gripper such that a horizontal inclination of the upper edge of the packaging container is detected and the gripper is suitably aligned in relation to the incline. For the sensor-based determination of an inclination of the upper edge of the packaging container two sensors, for example, which may take the form of light barriers, are spaced on the gripper, preferably at a distance smaller than the width of the packaging container. The two sensors are preferably arranged at the same height in relation to the transport device, for example to the surface of a conveyor belt. If the upper edge of a packaging container is inclined, as the gripper moves in a vertical direction above the upper edge the sensor located closest to the highest point of the upper edge will detect the edge first and the second sensor will detect this upper edge later. The incline of the packaging container can be determined through the detection of the upper edge of the packaging container at different points and the gripper can be appropriately aligned to the incline.

In another preferred version of the invention the gripper has a minimum of two contact surfaces which are arranged parallel to each other. The gripper has two contact surfaces for grasping and fixing the upper edge of the packaging container into position and the upper edge of the packaging container is located between the contact surfaces for the purposes of sensor-based detection. In order to fix the packaging container into place the contact surfaces are moved towards each other and pressed together, preferably using pneumatic equipment. Alternatively, one contact surface may remain immobile in a lateral direction in relation to the transport path and the other contact surface may be pressed against it. The contact surfaces are preferably aligned parallel to the transport path of the packaging containers. The two front sides of the contact surfaces are able to be moved vertically in relation to the direction of movement of the packaging containers and independently of the rear sides of the contact surfaces. As a result of the independent mobility of the front side and rear sides of the gripper, the contact surfaces can be brought into an incline which is thus parallel to any inclination of the upper edge of a packaging container. The gripper preferably moves vertically above the upper edge of a packaging container until the upper edge of the packaging container is detected on one side, remains in position on this side and presses the contact surfaces against together as soon as the upper edge of the packaging container is also detected on the other side.

In a further version of the process the aligned packaging container is transferred to a processing device, specifically a sealing unit, as a result of which the packaging container is grasped by the processing device and the packaging container will not be released by the aligning unit until it is grasped by the processing device. The processing device is preferably a sealing unit with a suitable feeder device. The feeder device may, for example, consist of two conveyor belts arranged parallel to each other with vertical conveying surfaces between which the packaging containers are clamped. The packaging container is moved as a result of the rotation of the conveyor belts around vertically rotating shafts. In order to avoid altering the alignment of the aligned upper edge of the packaging container during the transfer, the packaging container will not be released by the gripper until it has been fully grasped by the processing device. For this purpose, the processing device may have a section at the point of transfer where the distance between the conveyor belts is greater, whereby the width of the section is equivalent to at least the maximum width of a packaging container. Once the packaging container has been completely fed into this section with a larger distance between the conveyor belts, the conveyor belts may be pressed towards each other, preferably through the movement of one of the conveyor belts in the receiving section in order to fix the packaging container securely into place. After the processing device has fixed it into place, the gripper releases the packaging container.

In a preferred further development of the process the packaging container is grasped by the processing device below a fold line at which the top side of the packaging container is folded when being sealed. To seal the packaging containers, specifically packaging containers with a roll bottom or stepped-end cut, the top side of the packaging container is folded over at least once and then sealed. In order to enable accurate folding and sealing of the packaging container, the packaging container is transferred to the processing device, precisely aligned and grasped by it below the fold line.

In a process for the sealing of a minimum of one packaging container during which the filled packaging container is horizontally fed to the aligning unit so that the packaging container has an infeed side at the front in the direction of movement and a rear side and during which the packaging container is sealed on its upper edge, it is proposed in the invention that the packaging container be aligned before sealing by means of a process in accordance with claims 1 to 8. A welding process, specifically a hot-air welding process, is the preferred application for the sealing of the packaging containers. Firstly, the upper edge of the packaging container, such as a plastic woven bag with a stepped-end cut, is folded so that the folded section of the packaging container, e.g. the section with the stepped-end cut, is brought towards the outer wall of the packaging container. A welding unit, specifically a hot air nozzle, is placed between the folded section of the packaging container and the outer wall of the packaging container and the folded edge is sealed with the outer wall through the welding energy generated by the hot air flow. A pair of nip rollers located immediately behind the hot air nozzle in the direction of transport of the packaging containers press together the weld melt produced as a result of the hot air flow. The pressing together of the pairs of nip rollers may be carried out, for example, using a pneumatic mechanism. During the welding process the packaging container continues moving so that the hot air nozzle and the pair of nip rollers can be located in a fixed position.

In a device for the alignment of a minimum of one packaging container, specifically for the carrying out of a process in accordance with one of the claims 1 to 8, with a minimum of two sensors and a minimum of one gripper which can be moved at least horizontally and/or vertically, it is proposed in the invention that the gripper has a minimum of two sensors for the detection of the upper edge of the packaging container, that the gripper has a controllable suspension device for at least horizontal and vertical movement, that the gripper has at least one signal-conducting connection to a control unit, that the control unit has at least one signal-conducting connection to a minimum of two sensors on the gripper so that the gripper can be controlled based on the data registered by the sensors. The gripper is preferably located above a transport device, for example a conveyor belt, which conveys the packaging containers to be aligned. The gripper may be located such that it can be moved vertically above the upper edge of the packaging container. The unit has a suspension device for moving the gripper, which enables horizontal and vertical movement and a rotation in the vertical plane. The gripper may additionally, for example, be connected to a minimum of two control lines which may take the form of levers or connecting rods and which may be able to be moved up and down using control levers. The gripper may be thus suspended on both sides from the control levers so that both sides of the gripper can be moved independently of each other. This enables a precise movement of the gripper. The control levers may, for example, be able to be controlled using a sensor control unit. This unit for vertical height control may in turn also be fixed but capable of being moved along a horizontal sliding rail. Additionally, a controlled movement of the gripper in the horizontal plane may also be made possible using the control levers. Thus, a spatial movement of the gripper is enabled in all directions. The gripper has a minimum of two sensors, preferably optical sensors and specifically light barriers, with which the upper edge of the packaging container can be detected by sensors. The data recorded by the sensors are transmitted through a signal-conducting connection to a control unit for their evaluation. Based on these data the control of the gripper, specifically its alignment, is carried out, for which purpose it is coupled via a signal-conducting connection to the control unit. The device for the alignment of packaging containers may form a single unit, for example with a sealing unit or another packaging unit, or the device may be arranged as a stand-alone unit which can be combined at will with other units and adapted to them. The device can, for example, be arranged in a mobile form as a stand-alone unit.

In a preferred arrangement of the invention the gripper has a minimum of two contact surfaces which are arranged parallel to each other and in total a minimum of two sensors are located on the facing contact surfaces. The gripper has two parallel arranged contact surfaces between which the upper edge of the packaging container to be aligned is positioned. The contact surfaces can be pressed against each other to fix the packaging container into place. This can be achieved using, for example, a hydraulic, pneumatic or similar mechanism. During this, either both contact surfaces can move in relation to each other or only one contact surface is designed in a mobile form to be pressed against the second contact surface. A minimum of two sensors, specifically light barriers, are arranged for the detection of the upper edge of the packaging container on the inside areas of the facing contact surfaces. The sensors can, for example, also be located above the inside facing surfaces. The sensors are preferably arranged in such a way that one sensor is located in the direction of movement of the packaging containers at the front between the contact surfaces and a second at the rear between the contact surfaces. Here the distance between the sensors is preferably only slightly smaller than the maximum width of a packaging container. For alignment purposes the gripper with the two parallel arranged contact surfaces is moved vertically in such a way that the contact surfaces are virtually parallel to the transport device, for example to the surface of a conveyor belt. As soon as the upper edge of the packaging container is registered by one sensor, the vertical movement can be set on the side of the gripper on which the sensor is located. As soon as the other sensor also registers the upper edge of the packaging container, the vertical movement can also be interrupted on this side. Thus, both contact surfaces are aligned parallel to the upper edge of the packaging container. The contact surfaces are pressed against each other and the upper edge of the packaging container is thus fixed into place. The upper edge of the packaging container is correctly aligned through a further movement of the gripper into a position in which the contact surfaces are once more located parallel to the transport device, preferably horizontal. In addition, it is possible that the movement of the gripper when registering the upper edge of the packaging container is not immediately set on the appropriate side but that the gripper is moved forward along, for example, a preset remaining path and the gripper is then closed. This enables a simple setting of the gripper to, for example, the position of the fold line of the packaging container.

In a further arrangement of the invention the device has a sensor for the detection of a minimum of one position of a packaging container conveyed by a transport device. The sensor can, for example, take the form of an optical sensor, specifically a light barrier. The transport device is preferably a conveyor belt. The sensor is, for example, located above the conveyor belt so that the detection path of the sensor runs vertically to the direction of conveying. If a packaging container is being conveyed on the transport device, it passes through the light barrier from which a signal is able to be transmitted to the gripper. The gripper is moved from its stand-by position so that it can approach the upper edge of the packaging container.

In a further preferred arrangement of the invention the device has a minimum of one synchronization unit, specifically for synchronizing the movement speed of the transport device for the feed of the packaging containers and the gripper. The horizontal movement speed of the gripper and of the transport device must be synchronized so that the gripper, specifically the contact surfaces of the gripper, can be correctly brought into position over the upper edge of the packaging container which is being moved by the transport device. For this purpose, the transport device may have a sensor which passes the relevant movement speed to the gripper. Alternatively, a measuring wheel, specifically a digital measuring wheel, can be located with contact to the surface of the conveyor belt which records the transport speed of the conveyor belt through its speed of rotation and passes this on to the gripper.

In a device for the alignment and sealing of a packaging container, specifically for the carrying out of a process in accordance with claim 9, with a minimum of two sensors, a minimum of one gripper which can be moved at least horizontally and/or vertically and at least one transport device it is proposed that the gripper has a minimum of two sensors for the detection of the upper edge of the packaging container. The upper edge of the packaging container to be aligned can be correctly grasped and aligned by the gripper via the sensors. The aligned packaging container is fed on to a device for further processing, specifically a sealing unit. For this purpose, the device may have a unit for further processing with an appropriate transfer unit. The transfer unit can, for example, take the form of two conveyor belts which are mounted, for example, between vertically rotating shafts. The conveyor belts are in this case arranged in parallel so that they are in contact with each other for at least part of the distance traveled. The speed of rotation of the conveyor belts must be thereby precisely synchronized. Once a packaging container has been clamped, specifically the top part of a bag, it is transported onward between the conveyor belts. To receive a packaging container, the transfer unit has a section whose width is equivalent to at least the maximum width of a packaging container. In this section the conveyor belts have a greater distance from each other than in the subsequent sections. The width of the distance can be adjusted by, for example, traversable, vertically rotating shafts around which one of the two conveyor belts runs and whose position may be moved in the direction of the other conveyor belt. In this section with a larger gap between the conveyor belts the packaging container is transferred from the gripper and both conveyor belts are pressed against each other so that the packaging container is fixed into place. After the transfer unit has fixed the packaging container into place, the gripper releases it again. This ensures that the position of the upper edge of the packaging container does not change during the transfer of the packaging container from the gripper to the transfer unit. The packaging container is transported onward through the rotation of the conveyor belts and fed to a sealing unit. The sealing unit has a folding device in which the upper section of a packaging container is folded. Hot air is fed in via an air flow nozzle between the surface of the packaging container and the folded section of the packaging container. Through the hot air a weld melt is produced on the surface of the plastic material which is pressed together using nip rollers which are located behind the hot air nozzle in the direction of movement of the packaging containers.

The invention is explained in further detail below using a sample design shown in the drawing. The schematic representations are as follows:

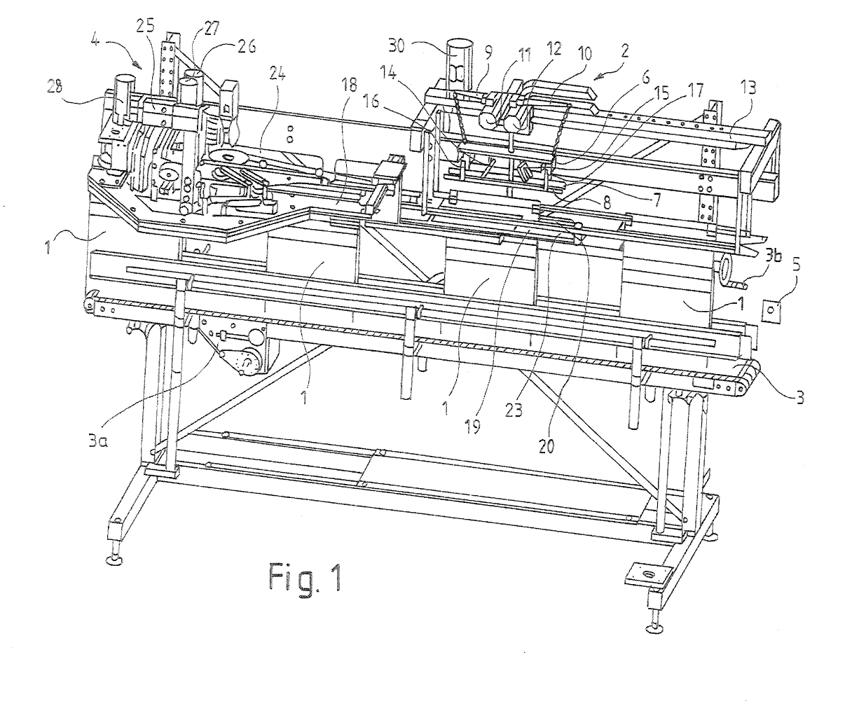

FIG. 1: A perspective view of a device for the sealing of packaging containers with an alignment device in accordance with the invention,

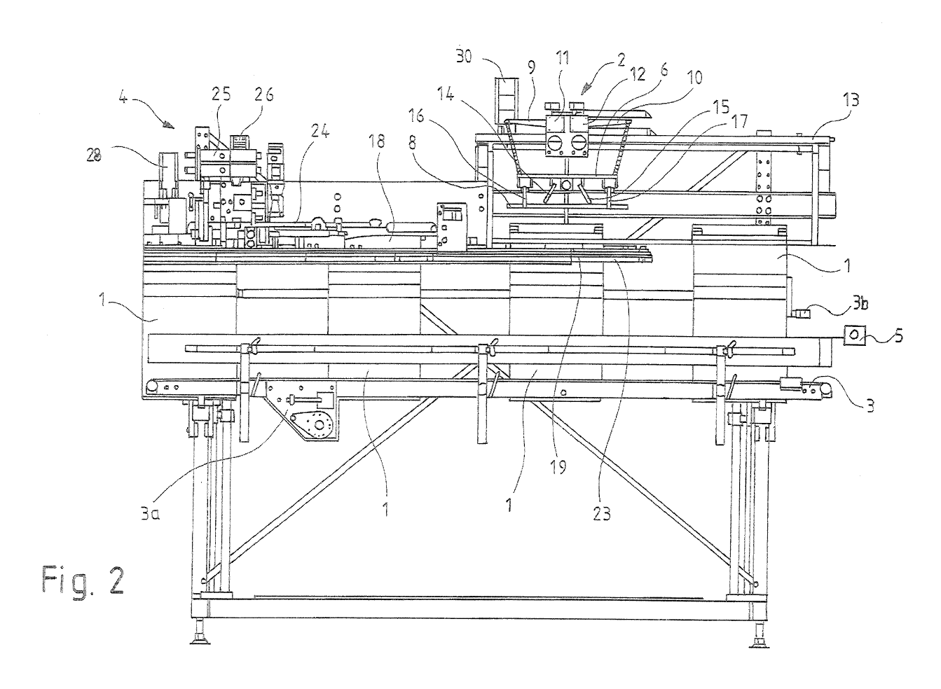

FIG. 2: A side view of a device for the sealing of packaging containers with an alignment device for packaging containers in accordance with the invention, and

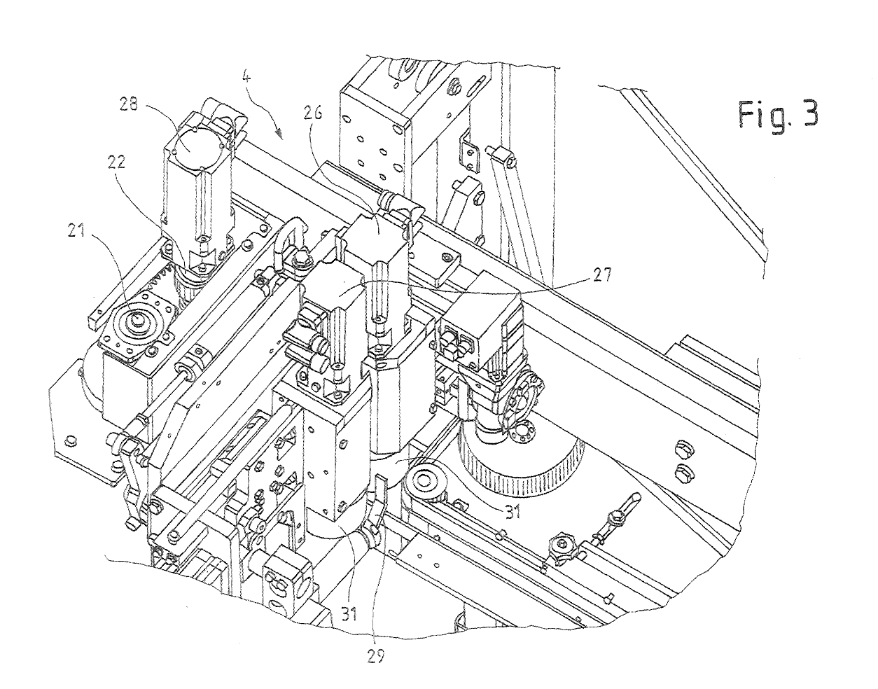

FIG. 3: A partial perspective view of the sealing unit.

In FIG. 1 a device is shown for the sealing of filled packaging containers 1 with a device in accordance with the invention for the alignment of the upper edges of the packaging containers 1. The aligning unit 2 for the alignment of the packaging containers essentially contains a gripper 6 which, at the least, can be moved horizontally and vertically to which the packaging containers 1 are fed via a transport device 3, specifically a conveyor belt. The transport speed of the transport device 3 can be adjusted, using a servo drive 3a, to the transport speed of upstream devices, such as a filling unit. All subsequent transport speeds can be adjusted to the transport speed given by the servo drive 3a. The height of the transport device can be adjusted to various packaging container formats using a height adjustment device 3b. The gripper 6 grasps the packaging containers 1, aligns them and passes them on to the sealing unit 4. The packaging containers 1 transported on the conveyor belt 3 are detected by a sensor 5, specifically a light barrier, whose detection range is located vertically to the conveying direction of the conveyor belt 3. The gripper 6 is suitably traversed to the position of the packaging container 1 to be aligned and is moved parallel to the packaging container 1 at the same horizontal speed as the transport speed of the packaging container 1. The gripper 6 is controlled during this by a servo drive 30. The gripper 6 has two contact surfaces 7, 8 arranged in parallel for grasping the packaging containers 1. For vertical movement the gripper 6 has connections on both sides to control levers 9, 10 which are connected to servo drives 11, 12. The gripper 6 can be moved horizontally along a guide rail 13. The gripper 6 is thus able, via the servo drives 11, 12, to be vertically traversed over the upper edge of a packaging container 1 so that the upper edge is located between the contact surfaces 7, 8 of the gripper 6. The gripper 6 has two sensors 14, 15, specifically light barriers, for the detection of the upper edge of the packaging container 1, whereby one sensor 14 is located in the direction of movement on the front side of the gripper 6 and one sensor 15 on the rear side of the gripper 6. During the vertical movement of the gripper 6 above the upper edge of the packaging container 1 the sensor 14 on the front side registers the position of the upper edge on the infeed side of the packaging container 1 and the sensor 15 on the rear side detects the position of the upper edge on the rear side of the packaging container 1. The front and rear sides of the gripper 6 are controlled independently of each other by the servo motors 11, 12 so that, even where the upper edge of the packaging container 1 is inclined, the contact surfaces 7, 8 of the gripper 6 can be aligned parallel to the inclined upper edge. If the upper edge of the packaging container 1 has been detected by the sensors 14, 15 on both sides, the contact surfaces 7, 8 are pressed against each other by pneumatic elements 16, 17. The upper edge of the packaging container 1 thus detected is now aligned into a horizontal position by a movement of the contact surfaces 7, 8 via the servo drives 11, 12. The packaging container is transferred to a feeder device 18 for the sealing unit 4 for further processing. The feeder device 18 consists of two parallel arranged conveyors 19, 20, which are mounted around vertically running shafts 21, 22 (see FIG. 3). The feeder device 18 is controlled by a servo drive 28. During this, the running surfaces of the conveyors 19, 20 remain in contact with each other so that the upper section of a packaging container 1 can be transported between the conveyors 19, 20. The feeder device grasps the packaging containers 1 below the fold line of the packaging containers 1. The feeder device 18 has a receiving section 23 whose width is at least the maximum width of a packaging container 1. Along the length of the receiving section 23 a minimum of one of the conveyors 19, 20 is capable of being traversed sideways so that the gap between the conveyors 19, 20 is increased. The aligned packaging container 1 is inserted by the gripper 6 into this widened gap and the conveyors 19, 20 and the upper edge of the packaging container 1 are brought into position through the movement of the mobile conveyor section 23. The upper edge of the packaging container 1 is thus fixed into place. After the feeder device 18 has fixed it into place, the upper edge of the packaging container 1 is released by the opening of the gripper 6. This prevents a change in the position of the upper edge of the packaging container 1 during the transfer between the gripper 6 and the feeder device 18. The sealing unit 4 has a folding rail 24 along which the packaging containers 1 are moved. The upper section of each of the packaging containers 1 is folded as a result of the shaping of the folding rail 24. A hot air welding device 25, which has a hot air nozzle and a pair of nip rollers, is used to seal the upper edge.

In FIG. 2 a side view is shown of a device for the sealing of packaging containers 1 with an alignment device in accordance with the invention as shown in FIG. 1. Alike components have been given the same designation. The aligning unit 2 can be traversed horizontally along a sliding rail 13. Vertical mobility is achieved by the use of two control levers 9, 10 which are connected to servo drives 11, 12. The front and rear sides of the gripper 6 can be vertically controlled independently of each other.

A partial view of a sealing unit is shown in FIG. 3. The conveyor belts of the feeder device are mounted around vertically running shafts 21, 22. The upper edges of the packaging containers 1 are sealed using a hot air nozzle 29 and a pair of nip rollers 31. The packaging container 1 is moved along the hot air nozzle 29, the hot air nozzle 29 being located between the folded section of the packaging container 1 and the front wall of the packaging container 1. Welding energy is fed to the packaging container 1 through the hot air nozzle 29 so that a weld melt is produced on the surface of the plastic material. This weld melt is pressed together by the pair of nip rollers which is controlled by two servo drives 26, 27 as a result of which the packaging container is firmly sealed.

All of the features mentioned in the above description and in the claims may be freely combined with the features of the independent claim. The disclosure of the invention is thus not restricted to the described or claimed combinations of features but rather all reasonable combinations of features within the terms of the invention may be regarded as being disclosed.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. A process for aligning a filled bag moved in a generally horizontal direction by a transport device toward a feeder device, wherein said filled bag comprises an infeed side moving in said generally horizontal direction and a rear side; said process for aligning comprising the steps of:
a) positioning an aligning unit near said transport device, wherein said aligning unit comprises a gripper proximate said filled bag; and wherein said gripper is capable of multidirectional movements;
b) using at least two sensors associated with said aligning unit for detecting an upper edge of said filled bag;
c) sending data sensed by said sensors to a control unit processing said data;
d) using said processed data and said control unit in communication with said gripper to control multidirectional movements of said gripper such that said gripper:
i) aligns with said upper edge of said filled bag;
ii) grasps said upper edge of said filled bag; and
iii) coordinates alignment of said upper edge of said filled bag with said generally horizontal direction.

16. The process of claim 15, wherein said multidirectional movements of said gripper comprise the steps of:
a) moving said gripper generally horizontally at the speed of said transport device; and
b) moving said gripper vertically above said upper edge of said filled bag.

17. The process of claim 16 comprising the step of positioning said sensors on said gripper.

18. The process of claim 17 comprising the step of supplying said gripper with at least two opposed generally parallel gripping surfaces.

19. The process of claim 18 further comprising the step of regulating movement of said filled container with said gripper until said filled container is received by said feeder device.

20. The process of claim 19, wherein at least a portion of said gripper is suspended superior to said upper edge of said filled bag.

21. The process of claim 18 further comprising the steps of:
a) positioning a transport device sensor proximate one or more of said filled bags transported by said transport device;
b) detecting positions of said filled bags transported by said transport device; and
c) sending position data to said control unit.

22. A system aligning and sealing a plurality of filled bags, wherein each of said filled bags comprises an infeed side and a rear side; said system comprising:
a) a conveyor moving said plurality of filled bags in a generally horizontal direction;
b) a conveying sensor detecting positions of said plurality of filled bags transported by said conveyor;
c) an aligning unit near said conveyor; said aligning unit comprising:
i) at least two aligning sensors for detecting an upper edge of one of said plurality of filled bags; and
ii) a gripper, capable of multidirectional movements, proximate said upper edge of said one of said plurality of filled bags;
d) a feeder device feeding said one of said plurality of filled bags into a sealing unit sealing said bags; and
e) a controller receiving and processing data from said conveying sensor and said aligning sensors; said controller controlling movements of said conveyor and said aligning unit such that said gripper:
i) aligns with said upper edge of said one of said plurality of filled bags;
ii) grasps said upper edge of said one of said plurality of filled bags; and
iii) adjusts said upper edge and said infeed side of said one of said plurality of filled bags for reception by said feeder device.

23. The system of claim 22, wherein at least a portion of said gripper comprises two opposed generally parallel gripping surfaces and said aligning sensors, wherein a distance between said aligning sensors positioned on one of said generally parallel gripping surfaces is less than a length of said upper edge of said one of said plurality of filled bags, and wherein said gripper is suspended superior to said upper edge of said one of said plurality of filled bags.

24. The system of claim 23, wherein said sealing unit grasps said filled bag below a fold line of said filled bag prior to sealing said filled bag.

25. A system aligning a plurality of filled bags; said system comprising:
a) a conveyor moving said plurality of filled bags toward a feeder device;
b) a conveying sensor detecting positions of said plurality of filled bags transported by said conveyor;
c) an aligning unit near said conveyor; said aligning unit comprising:
i) at least two aligning sensors for detecting an upper edge of one of said plurality of filled bags; and
ii) a gripper, capable of multidirectional movements, proximate said upper edge of said one of said plurality of filled bags; and
d) a controller receiving and processing data from said conveying sensor and said aligning sensors; said controller controlling movements of said conveyor and said aligning unit such that said gripper:
i) aligns with said upper edge of said one of said plurality of filled bags;
ii) grasps said upper edge of said one of said plurality of filled bags; and
iii) adjusts said upper edge of said one of said plurality of filled bags for reception by said feeder device.

26. The system of claim 25, wherein at least a portion of said gripper is suspended superior to said upper edge of said one of said plurality of filled bags.

27. The system of claim 26, wherein said gripper comprises at least two opposed generally parallel gripping surfaces.

28. The system of claim 27, wherein said gripper comprises said aligning sensors, and wherein a distance between said aligning sensors positioned on one of said generally parallel gripping surfaces is less than a length of said upper edge of said one of said plurality of filled bags.

29. A process for aligning a filled container moved in a generally horizontal direction by a conveyor toward a feeder device transferring said filled container into a sealing unit sealing said filled container; said process for aligning comprising the steps of:
a) positioning an aligning unit near said conveyor; said aligning unit comprising a gripper proximate said filled container and capable of multidirectional movements;
b) locating a conveying sensor about said conveyor for detecting positions of said filled container;
c) locating at least two aligning sensors on said aligning unit for detecting an upper edge of said filled container;
d) sending data sensed by said sensors to a controller;
d) using said data received by said controller to control:
i) movement of said conveyor; and
ii) said multidirectional movements of said gripper such that said gripper: aligns with said upper edge of said filled container; grasps said upper edge of said filled container; and adjusts said upper edge and said filled container for entry into said feeder device.

30. The process of claim 29, wherein said multidirectional movements of said gripper comprise the steps of:
a) moving said gripper vertically above said upper edge of said filled container; and
b) moving said gripper generally horizontally at the speed of said conveyor.

31. The process of claim 30 comprising the step of supplying said gripper with at least two opposed generally parallel gripping surfaces releasably grasping first and second sides of said upper edge of said filled container.

32. The process of claim 31 further comprising the steps of:
a) regulating movement of said filled container with said gripper until said filled container is received by said feeder device;
b) releasing said filled container from said gripper when said filled container is received by said feeder device; and
c) regulating movement of said filled container with said feeder device until said filled container is received by said sealing unit.

33. The process of claim 32, wherein at least a portion of said gripper is suspended superior to said upper edge of said filled container.

34. The process of claim 33 comprising the step of locating said aligning sensors on one of said generally parallel gripping surfaces such that a distance between said aligning sensors is less than a length of said upper edge of said filled container.
